(19) United States
(12) Patent Application Publication
(10) Pub. No.: US 2019/0193527 A1
(43) Pub. Date: Jun. 27, 2019

(54) CLUSTER IONIZER FOR VEHICLE UTILIZING NEEDLE ELECTRODES

(71) Applicant: ELIM ELECTRONICS CORPORATION, Cheonan-Shi (KR)

(72) Inventor: Jae Duck JUNG, Cheonan-Shi (KR)

(21) Appl. No.: 16/197,046

(22) Filed: Nov. 20, 2018

(30) Foreign Application Priority Data
Dec. 21, 2017 (KR) 10-2017-0177084

(51) Int. Cl. B60H 3/00; H01T 23/00; F24F 3/16

(52) U.S. Cl. CPC B60H 3/0078; F24F 2003/1682; F24F 3/16; H01T 23/00

(57) ABSTRACT

Provided is a cluster ionizer for a vehicle. The cluster ionizer uses a needle electrode and includes a case, and a housing disposed in the interior of the case. An ion generating element for generating positive ions and negative ions by applying a driving voltage, and a winding coil and a circuit board for generating the driving voltage that is applied to the ion generating element are mounted in the interior of the housing having a hollow housing part that is communicated with the outside of the housing and is blocked from the interior of the housing. A needle electrode that has sharp part, opposite ends of which are formed sharply to have two needle shapes as the ion generating elements, and a substantially T-shaped protection part extends between the sharp parts so that a direction physical contact with the sharp parts is interrupted.

### BACKGROUND OF THE INVENTION

### 1. Field of the Invention

The present invention relates to an ion generator or cluster ionizer for a vehicle including an ion generating element that generates positive ions and negative ions by using a high voltage.

### 2. Description of the Prior Art

In recent years, needs for development of technologies for purifying air in the interiors of vehicles for clean and comfortable environments have increased. Conventionally, air cleaners designed to generate flows of circulation air by discharging air through a filter after air is suctioned for purifying interior air of a vehicle and continuously collect buoyant materials in the air with a filter are widely used.

However, because the buoyant material that float in the air include fine particles of sizes that are smaller than the apertures of the filter, bacteria such as fungi and colon bacteria, it is impossible to remove the materials only with the filter. In particular, because the bacteria propagate while being collected in the filter and return to the interior of the vehicle together with the flows of the circulation air, it is difficult to expect a sufficient effect that is to be obtained, only with the filter.

In recent years, a comfortable interior space of a vehicle is to be obtained by removing bacteria by using an anti-fungal filter, but a satisfactory effect cannot be obtained in the real situations.

In order to solve the problems, in recent years, cluster ion generators and plasma ion generators have been suggested and installed and operated in the air conditioning apparatuses for vehicles and the like.

Among them, the cluster ion generators are devices (referred to as ‘cluster ionizers’ in this technical field) for generating positive ions and negative ions by using high frequency oscillations. The positive ions and the negative ions are generated by ionizing the moisture in air by using high frequency oscillations, and have forms in which a plurality of water molecules are attached to the vicinities of hydrogen ions (H+) or oxygen ions (O2−), that is, forms of cluster ions. The ions discharged to the air gather around suspended particles, generate chemical reactions, form hydrogen peroxide (H₂O₂) or hydroxyl radicals as active species, perform oxidation reactions of removing hydrogen from the suspended particles, deactivate the suspended particles, and sterilize suspended bacteria.

The air purification is performed by the functions of ions that are discharged into a target space and spread out to the entire space, and the ions acts on the floating bacteria to sterilize the floating bacteria and further acts on the floating bacteria to make the malodorous molecules and harmful molecules odorless and harmless so that a satisfactory purification effect may be obtained throughout the entire target space. Moreover, the cluster ions discharged into the space are ions that are present in the nature, are not harmful to the human body, and are converted into H₂O (water) through an oxidation reaction.

The cluster ionizer that is currently practically used or known in documents includes a primary coil for high frequency oscillations and a secondary coil for generation of high voltages with respect to a core of a ferrite material, and soft epoxy is impregnated as an insulating filler for the purpose of insulation between the coils between the coils and the core of a ferrite material. A representative patent document may include Korean Patent Utility Model No. 20-0378008 (Patentee: Winix Inc., entitled ‘Ion Generating Apparatus’).

However, because the secondary coil is heated due to the generation of high voltages, heat is transferred to the core of a ferrite material, on which the secondary coil is wound, and the soft epoxy as an insulating filler impregnated around the core. Then, because the thermal expansion rate of the core of a ferrite material and the soft epoxy as an insulating filler are different, the core of a ferrite material may be damaged or broken. In particular, the phenomenon is more severe in the winter rather than in the summer.

In the cluster ionizer having the above-mentioned structure, soft epoxy is impregnated in the interior of the cluster ionizer to minimize the problem of damage or breaking of the core of a ferrite material, and the impregnation rate deteriorates to about 65% so that the cluster ionizer cannot be used for a long time because an internal pressure short circuit and/or a progressive internal pressure short circuit between the coils are generated.

Moreover, when a conventional electrode, particularly, a sharp electrode is used, not only the electrode is damaged but also users may be injured due to the electrode.

### PRIOR TECHNICAL DOCUMENTS

### [Patent Documents]

Korean Patent Utility Model No. 20-0378008 (Patentee: Winix Inc., entitled ‘Ion Generating Apparatus’)

### SUMMARY OF THE INVENTION

The present has been made in an effort to solve the above-mentioned problems, and provides a cluster ionizer that is structured to prevent a core of a ferrite material from being damaged or broken due to an insulating filler, a thermal expansion rate of which is different from that of the core of a ferrite material, for example, when a secondary coil emits heat due to generation of high voltages of the secondary coil.

The present invention also provides a cluster ionizer that is structured to interrupt an electrical short circuit by improving an impregnation rate of a filler that is filled in the interior of the cluster ionizer.

The present invention also provides a cluster ionizer that is structured to interrupt an electrical short circuit by improving an impregnation rate of a filler that is filled in the interior of the cluster ionizer.

The present invention also provides a cluster ionizer that is structure to originally interrupt an electrical short circuit between coils by forming an insulating bather between the coils.

The present invention also provides a cluster ionizer for a vehicle that uses an electrode that neither damage the electrode itself nor injure a human body due to the electrode.

In accordance with an aspect of the present invention, there is provided a cluster ionizer for a vehicle using a needle electrode, the cluster ionizer comprising: a case; and a housing disposed in the interior of the case, wherein an ion generating element for generating positive ions and negative ions by applying a driving voltage, and a winding coil and a circuit board for generating the driving voltage that is applied to the ion generating element are mounted in the interior of the housing having a hollow housing part that is communicated with the outside of the housing and is blocked from the interior of the housing, wherein the coil is wound in the interior of the housing having the hollow housing part, and a core of a ferrite material is inserted into and disposed in the hollow housing part in which the coil is wound, wherein the interior of the housing is filled with an insulating filler, and wherein a needle electrode that has sharp part, opposite ends of which are formed sharply to have two needle shapes as the ion generating elements, and a substantially T-shaped protection part extends between the sharp parts so that a direction physical contact with the sharp parts is interrupted.

Sections of ends of the T-shaped protection parts may form waved surfaces.

Ends of the T-shaped protection parts may be coated with a silicon material.

The core of a ferrite material may include a first core that is inserted from the upper side to the lower side, and a second core inserted from the lower side to the upper side.

The first core member may include: a core portion inserted into the hollow housing part; an extending portion extending to an upper end core portion horizontally; and a support portion extending from one end of the extending portion to the vertically lower side, wherein the second core member includes: a core portion inserted into the hollow housing part; an extending portion extending to a lower end of the core portion horizontally; and a support portion extending from one end of the extending portion to the vertically lower side, and an end of the support portion of the first core member and an end of the support portion of the second core member may be adjacent to each other or contact each other.

The extending portion and the support portion of the first core member and the extending portion and the support portion of the second core member may be compulsorily fitted with each other by a stapler-shaped elastic body to be elastically supported.

Grooves may be formed at portions of the first core member and the second core member, at which the stapler-shaped elastic body is disposed, such that the elastic body is fixed to the first core member and the second core member.

The filler may be a hard epoxy resin.

A change rate of high voltage of the cluster ionizer at 20° C. below zero may not be more than 5%.

The cluster ionizer may have an impregnation rate of not less than 95%.

To the present invention, a problem of deforming or breaking a core of a ferrite material due to rapid thermal expansion of a filler that is filled in a housing of a cluster ionizer because of different thermal expansion rates thereof may be completely interrupted.

According to the present invention, a short circuit phenomenon between coils or electronic parts may be interrupted almost perfectly by improving the impregnation rate to not less than 95%, in more detail, not less than 98% as a hard epoxy resin is impregnated in the interior of a cluster housing.

Further, according to the present invention, a large amount of negative ions may be generated while damage of a needle electrode is prevented and damage to a human body due to the needle electrode may be prevented.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view schematically illustrating a main part of a cluster ionizer according to an embodiment of the present invention;

FIG. 2 is an exploded perspective view of the cluster ionizer illustrated in FIG. 1;

FIG. 3 is a sectional view schematically illustrating a main part of the cluster ionizer illustrated in FIG. 1;

FIG. 4 is an exploded view of a part of the cluster ionizer illustrated in FIG. 3;

FIG. 5 is a view illustrating an ion generating element that is applied to the cluster ionizer of the present invention, that is, a needle electrode;

FIG. 6 is a view illustrating an ion generating element of another form, which is applied to the cluster ionizer of the present invention, that is, a needle electrode; and

FIG. 7 is a view illustrating needle electrodes of various forms (see experimental examples).

### DETAILED DESCRIPTION OF THE EXEMPLARY EMBODIMENTS

Hereinafter, the present invention will be described in more detail with reference to the accompanying drawings. In a description of the present invention, known functions or configurations will not be described to make the essence of the present invention clear. Throughout the specification, the same or like reference numerals denote the same or like elements.

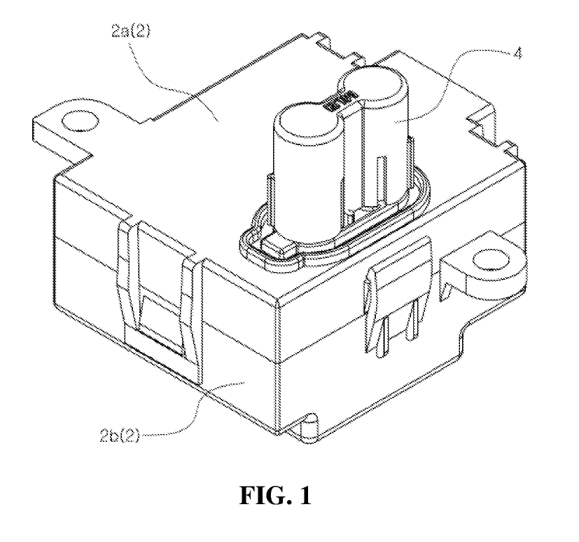

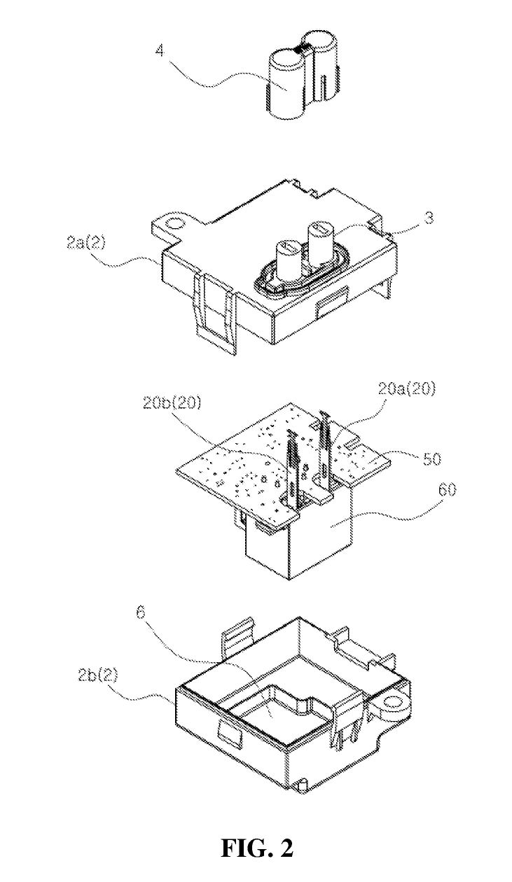

FIGS. 1 to 4 illustrate a cluster ionizer for a vehicle according to an embodiment of the present invention.

The cluster ionizer according to an embodiment of the present invention is applied to an air conditioning apparatus or system of a vehicle. The cluster ionizer generates positive ions and negative ions by ionizing moisture in air through high-frequency oscillations. The peripheries of the positive ions and the negative ions have the forms in which a plurality of water molecules are attached to the positive ions and the negative ions, that is, the forms of cluster ions. The ions discharged to the air gather around suspended particles, generate chemical reactions, form hydrogen peroxide (H₂O₂) or hydroxyl radicals as active species, perform oxidation reactions of removing hydrogen from the suspended particles, deactivate the suspended particles, and sterilize suspended bacteria. The present invention improves the performance of a cluster ionizer by improving the structure of the cluster ionizer to eliminate or minimize a possibility of damaging or breaking a core of a ferrite material, on which coils are wound, and by selectively applying a filler used for a purpose of insulation to remarkably improve impregnation rate and minimizing a short-circuit between coils.

Referring to FIGS. 1 to 4, the cluster ionizer for a vehicle according to an embodiment of the present invention includes cases 2 (2a and 2b), a housing 60 seated on a seating part 6 formed in the interior of the case 2 and on which various parts are mounted, and a hollow housing part 62 formed in the interior of the housing 60. An ion generating element, that is, an electrode is protected by a protection cap 4 on the outside of the case 2.

An ion generating element 20 for generating positive ions and negative ions by applying a driving voltage, a coil 40 for generating the driving voltage that will be applied to the ion generating element 20, and a circuit board 30 of various forms, which are widely known in the art are included in the interior of the housing 60. The circuit board itself is widely known in the art, and a description thereof will be omitted if possible to avoid the complexity of the description.

Further, a positive electrode 20a for generating positive ions and a negative electrode 20b for generating negative ions are included on the outside of the housing 60 as illustrated. The electrodes are electrically connected to the components mounted in the interior of the housing 20 (20a and 20b).

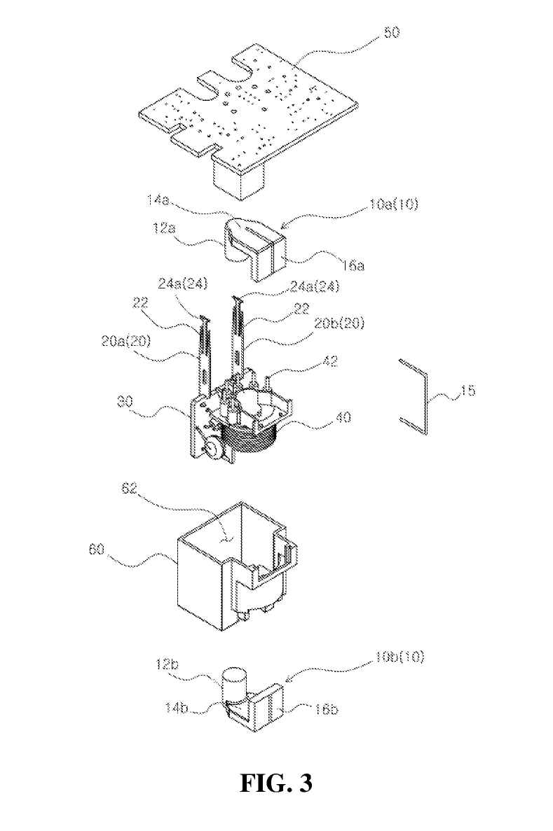

Further, in particular, as illustrated in FIG. 3, the hollow housing part 62 that communicates with the outside of the housing 60 and is blocked from the interior of the housing 60 is formed in the housing 60. That is, the hollow housing part denoted by reference numeral 62 is a hole that passes through the interior of the housing 60, and the hole is blocked from the interior of the housing 60 in a fluidic aspect. Further, the housing part that forms the hole is formed of an insulating material.

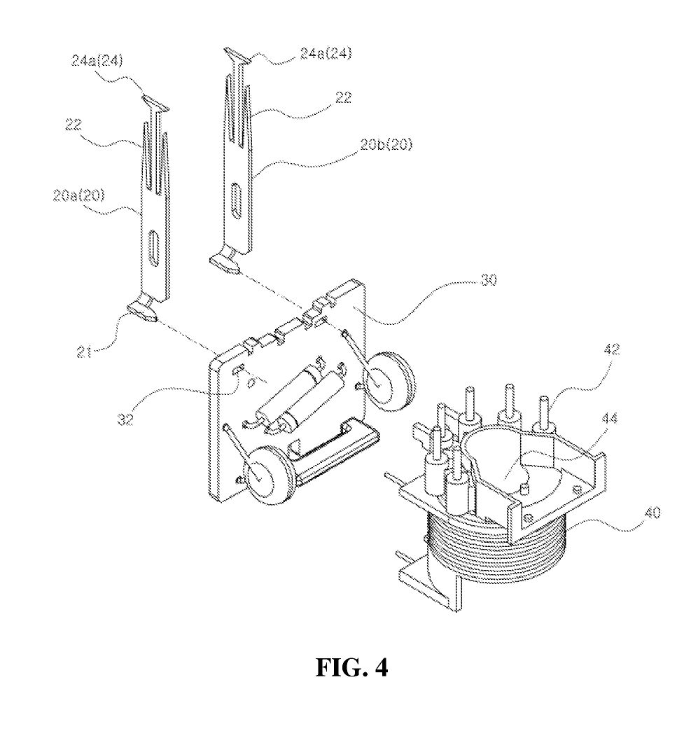

A coil 40 is wound in the interior of the housing, in which the hollow housing part 62 is formed, particularly as illustrated in FIGS. 3 and 4, a plurality of input terminals or output terminals 42 are disposed vertically in the drawings particularly as illustrated in FIG. 3, and they are connected to connection terminals of the circuit board disposed in the interior of the housing 60.

A core 10 of a ferrite material is inserted into the hollow housing part 62. That is, although the coil 10 and the coil 40 are blocked from each other in a fluidic aspect, the coil 40 is wound around the core 10.

Particularly as illustrated in FIG. 3, the core 10 of a ferrite material includes a first core member 10a that is inserted into the hollow housing part 62 from the upper side to the lower side in the drawings, and a second core member 10b that is inserted from the lower side to the upper side in the drawings.

The first core member 10a in turn includes a core portion 12a that is inserted substantially into the hollow housing part 3, an extending portion 14a that extends to an upper end of the core portion 12a horizontally, and a support portion 16a that extends to the vertically lower side in the drawings from one end of the extending portion 14a.

The second core member 10a corresponding to the first core member 10a has a core portion 12b that is inserted substantially into the hollow housing part 3, an extending portion 14b that extends to an upper end of the core portion 12b horizontally, and a support portion 16b that extends to the vertically upper side in the drawings from one end of the extending portion 14b. The core member 10a and the second core member 10b form the core 10 as a pair. Then, it will be very advantageous in an aspect of stability if one end of the support portion 16a of the first core member 10a and one end of the support portion 16b of the second core 10b contact each other.

In this way, particularly as illustrated in FIG. 3, grooves are formed at central portions of both the extending portions 14a and 14b and both the support portions 16a and 16b of the core 10 of a ferrite material, and stapler-shaped fixing members 15 are inserted into and coupled to the grooves so that the core 10 of a ferrite material is stably inserted into and fixed to the interior of the coil 40 wound in the interior of the housing 60, that is, the hollow housing part 62. Here, the stapler-shaped fixing member 15 includes an elastic body such as a spring.

An insulating filler 40 is filled in the interior of the housing 60, on which the coil 40 and various circuit parts are mounted, and is hardened for the purpose of insulating the coil 40 and the coil 40 and/or the circuit parts.

Then, a widely used hard epoxy resin is used as the insulating filler. Although a soft epoxy resin is conventionally used as an insulating filler to minimize damage or breaking of the core, the present invention may obtain an advantage of improving impregnation as an advantage of a hard epoxy resin maximally because a possible of contact of the core and the insulating filler is completely excluded. The present invention may obtain an impregnation rate of not less than 90%, in detail, not less than 95%, and in more detail not less than 98%, and accordingly, a short circuit between the coils, in detail, between electronic parts may be mostly prevented for a long time.

Further, according to the present invention, a needle electrode 20 that has sharp parts 22, opposite ends of which are formed sharply to have two needle shapes as the ion generating elements, and a substantially T-shaped protection part 24 extends between the sharp parts 22 so that a direction physical contact with the sharp parts 22 may be interrupted. The needle electrode is fixed to a fixing hole 32 formed in the circuit board 30. To achieve this, as illustrated in FIG. 4, an insertion boss 21 is formed at a lower end of the needle electrode 20.

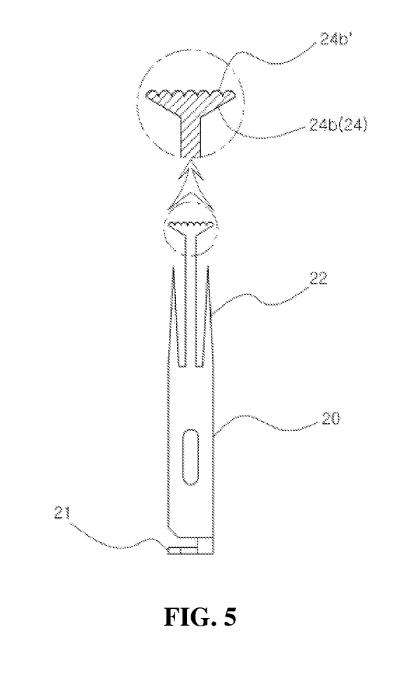

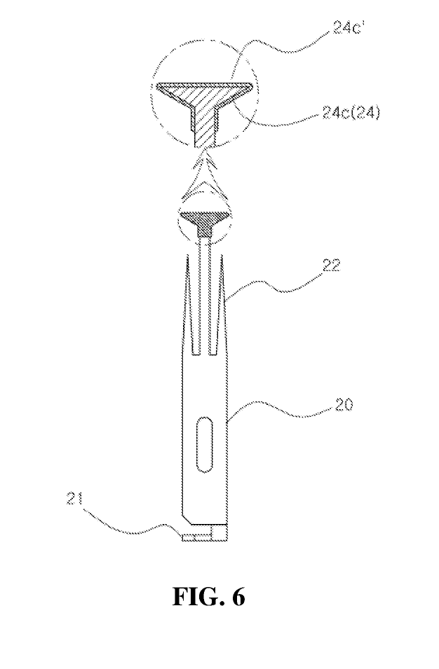

The needle electrode in the form illustrated in FIGS. 5 and 6 may be preferably used as a needle electrode in another from that may be used in the cluster ionizer for a vehicle according to the present invention.

In the needle electrode illustrated in FIG. 5, end sections of the T-shaped protection parts 24 and 24b form waved surfaces 24b′.

In the needle electrode illustrated in FIG. 6, end sections of the T-shaped protection parts 24 and 24b are coated with a silicon material 24c′.

The above-mentioned contents are identified through the following experimental examples. The following experimental examples are provided only for description of the present invention, and the present invention is not limited to the following experimental examples.

### EXPERIMENTAL EXAMPLE 1

In the experimental example, changes of impregnation rate were measured when the interior of a housing of a cluster ionizer was filled with a conventional soft epoxy resin and when the interior of a housing of a cluster ionizer was filled with a hard epoxy resin according to the present invention. The soft epoxy resin and the hard epoxy resin used in the experimental example are products of Chemtech Co., Ltd. The conditions and results used in the experimental example are suggested in Table 1.

TABLE 1

| | |
|---|---|
| Soft epoxy resin | Hard epoxy resin |

| | | |
|---|---|---|
| Main | EF-120A4 | EF-120A |
| material | | |
| Hardener | EF-120B7 | EF-120B |
| Composition ratio (with | 100:20 | 100:30 |
| reference to weight) | | |

| | | | | |
|---|---|---|---|---|
| Pressure | 5 | torr | 1.5 | torr |
| (torr) | | | | |
| Time for | 30 | minutes | 5 | minutes |
| impregnation | | | | |
| Preheating | 50° | C. | 100° | C. |
| temperature for | | | | |
| product | | | | |
| Preheating | 1 | hour | 1 | hour |
| time for product | | | | |
| Hardening | 60° | C. | 100° | C. |
| temperature | | | | |
| Hardening | 4 | hour | 6 | hour |
| time | | | | |

As suggested in Table 1, the vacuum degree when the conventional soft epoxy resin was used is 5 torr, but the vacuum degree when the hard epoxy resin was used as in the present invention was 1.5 torr. The high vacuum means that impregnation rate was considerably improved.

Further, in order to know impregnation rate when the hard epoxy resin was used as in the present invention, the cluster ionizer that is impregnated in the above-mentioned condition was cut to see an impregnation degree for an area. As a result, the impregnation rate of the cluster ionizer according to the present invention was not less than 95%.

### EXPERIMENTAL EXAMPLE 2

In the experimental example, changes of high pressure at 20° C. below zero for the cluster ionizers of a conventional core embedding type and a core mounting type according to the present invention were measured. The results are suggested in Table 2.

TABLE 2

| | Core embedding type | Core mounting type |
|---|---|---|
| | (conventional) | (the present invention) |
| Change of | 500 V | 100 V |
| high pressure at 20° C. | | |
| below zero | | |

Through Table 2, it may be seen that the change rate of voltage increases rapidly as temperature decreases to below zero in the core embedding type but the change rate of voltage hardly changes while maintaining not more than 5% even though temperature decreases to below zero in the core mounting type.

### EXPERIMENTAL EXAMPLE 3

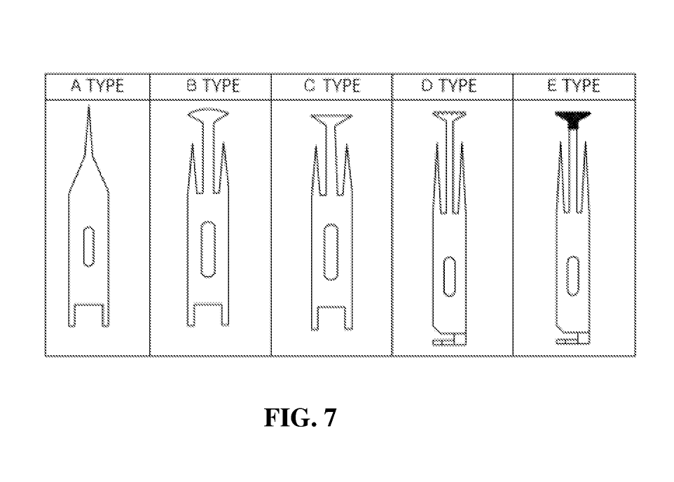

In the experimental example, the amounts of generated negative ions and positive ions according to the shapes and materials of the electrodes were experimented. In the experiment condition, (+/−) 4.0 kV was used as a required voltage. The shape of the electrode is suggested in FIG. 7. Table 3 suggests comparisons of the amounts of generated negative ions and positive ions according to the shapes of the electrodes illustrated in FIG. 7.

TABLE 3

| | Type A | Type B | Type C | Type D | Type E |
|---|---|---|---|---|---|
| Negative | 918, 837 | 575, 253 | 936, 390 | 941, 568 | 932, 366 |
| ions | | | | | |
| Positive | 394, 917 | 466, 037 | 561, 813 | 553, 435 | 575, 432 |
| ions | | | | | |

As can be seen through Table 3, the needle electrodes of type C, type D, and type D generates the highest relative amount of negative ions with respect to the positive ions. The electrodes may not only protect the needle electrodes in their shapes but also generates a considerable amount of negative ions, which is suitable for the present invention.

Although the embodiments of the present invention has been described, it will be understood by an ordinary person in the art that the present invention may be variously corrected and modified without departing from the spirit of the present invention described in the claims.

What is claimed is:

1. A cluster ionizer for a vehicle using a needle electrode, the cluster ionizer comprising:
a case; and
a housing disposed in the interior of the case,
wherein an ion generating element for generating positive ions and negative ions by applying a driving voltage, and a winding coil and a circuit board for generating the driving voltage that is applied to the ion generating element are mounted in the interior of the housing having a hollow housing part that is communicated with the outside of the housing and is blocked from the interior of the housing,
wherein the coil is wound in the interior of the housing having the hollow housing part, and a core of a ferrite material is inserted into and disposed in the hollow housing part in which the coil is wound,
wherein the interior of the housing is filled with an insulating filler, and
wherein a needle electrode that has sharp part, opposite ends of which are formed sharply to have two needle shapes as the ion generating elements, and a substantially T-shaped protection part extends between the sharp parts so that a direction physical contact with the sharp parts is interrupted.

2. The cluster ionizer of claim 1, wherein sections of ends of the T-shaped protection parts form waved surfaces.

3. The cluster ionizer of claim 1, wherein ends of the T-shaped protection parts are coated with a silicon material.

4. The cluster ionizer of claim 1, wherein the core of a ferrite material includes a first core that is inserted from the upper side to the lower side, and a second core inserted from the lower side to the upper side.

5. The cluster ionizer of claim 4, wherein the first core member includes:
a core portion inserted into the hollow housing part;
an extending portion extending to an upper end core portion horizontally; and
a support portion extending from one end of the extending portion to the vertically lower side,
wherein the second core member includes:
a core portion inserted into the hollow housing part;
an extending portion extending to a lower end of the core portion horizontally; and
a support portion extending from one end of the extending portion to the vertically lower side, and
wherein an end of the support portion of the first core member and an end of the support portion of the second core member are adjacent to each other or contact each other.

6. The cluster ionizer of claim 5, wherein the extending portion and the support portion of the first core member and the extending portion and the support portion of the second core member are compulsorily fitted with each other by a stapler-shaped elastic body to be elastically supported.

7. The cluster ionizer of claim 6, wherein grooves are formed at portions of the first core member and the second core member, at which the stapler-shaped elastic body is disposed, such that the elastic body is fixed to the first core member and the second core member.

8. The cluster ionizer of claim 7, wherein the filler is a hard epoxy resin.

9. The cluster ionizer of claim 8, wherein a change rate of high voltage of the cluster ionizer at 20° C. below zero is not more than 5%.

10. The cluster ionizer of claim 8, wherein the cluster ionizer has an impregnation rate of not less than 95%.
